(19) United States
(12) Patent Application Publication
(10) Pub. No.: US 2026/0282165 A1
(43) Pub. Date: Sep. 17, 2026

(54) METHODS, DEVICES, AND COMPUTER READABLE MEDIUM FOR COMMUNICATION

(71) Applicant: NEC Corporation, Tokyo (JP)

(72) Inventors: Lin LIANG, Beijing (CN); Gang WANG, Beijing (CN)

(73) Assignee: NEC Corporation, Tokyo (JP)

(21) Appl. No.: 19/469,611

(22) PCT Filed: Mar. 31, 2023
(86) PCT No.: PCT/CN2023/085566

§ 371 Date: Sep. 26, 2025

(51) Int. Cl. H04W 76/40; H04L 5/00; H04W 72/232

(52) U.S. Cl. CPC H04W 76/40; H04L 5/0007; H04W 72/232

(57) ABSTRACT

Embodiments of the present disclosure are related to PBCH and CORESET #0 configuration and behavior for operation on dedicated spectrum less than 5 MHz. A terminal device determines that a communication between the terminal device and a network device is operating on a dedicated spectrum of which bandwidth is less than a predetermined bandwidth. The network device transmits a SSB on a PBCH to the terminal device. A set of resource elements in the PBCH with subcarrier number k is set to zero, the set of resource elements is in one or more resource blocks, and k is relative to a start of the SS/PBCH block and k is in a range from 0 to a first predetermined number and/or a range from a second predetermined number to a total number of subcarriers in the PBCH. In this way, it can save resources by reusing the resources.

### TECHNICAL FIELD

Embodiments of the present disclosure generally relate to the field of telecommunication, and in particular, to methods, devices, and computer readable medium for dedicated spectrum.

### BACKGROUND

Several technologies have been proposed to improve communication performances. New Radio (NR) systems need more efficient and flexible spectrums. For example, the efficiency and flexibility of the spectrums may be enhanced by multi-carrier jointly scheduling and dynamic spectrum sharing. Moreover, NR may support narrower dedicated spectrum. Therefore, it is worth studying on the dedicated spectrum.

### SUMMARY

In general, example embodiments of the present disclosure provide a solution for dedicated spectrum.

In a first aspect, there is provided a terminal device. The terminal device comprises a processor, configured to cause the terminal device to: determine that a communication between the terminal device and a network device is operating on a dedicated spectrum of which bandwidth is less than a predetermined bandwidth; and receive, from the network device, a synchronization signal/physical broadcast channel (SS/PBCH) block on a PBCH, and wherein a set of resource elements in the PBCH with subcarrier number k is set to zero, the set of resource elements is in one or more resource blocks, and wherein k is relative to a start of the SS/PBCH block and k is in a range from 0 to a first predetermined number and/or a range from a second predetermined number to a total number of subcarriers in the PBCH.

In a second aspect, there is provided a terminal device. The terminal device comprises a processor, configured to cause the terminal device to: determine that a communication between the terminal device and a network device is operating on a dedicated spectrum of which bandwidth is less than a predetermined bandwidth; receive, from the network device, a synchronization signal/physical broadcast channel (SS/PBCH) block on a PBCH; and determine a subcarrier offset from a first subcarrier in a common resource block to a first subcarrier of the SS/PBCH block, and wherein an offset between the common resource block and the SS/PBCH block is defined associated with a value of the subcarrier offset.

In a third aspect, there is provided a terminal device. The terminal device comprises a processor, configured to cause the terminal device to: determine that a communication between the terminal device and a network device is operating on a dedicated spectrum of which bandwidth is less than a predetermined bandwidth; and determine a subset of resource blocks from a control resource set, and wherein physical downlink control channel (PDCCH) and corresponding demodulation reference signal (DMRS) resource elements of a resource element group with a resource block outside the subset of resource blocks are set to zero.

In a fourth aspect, there is provided a network device. The network device comprises a processor, configured to cause the network device to: determine that a communication between a terminal device and the network device is operating on a dedicated spectrum of which bandwidth is less than a predetermined bandwidth; and transmit, to the terminal device, a synchronization signal/physical broadcast channel (SS/PBCH) block on a PBCH, and wherein a set of resource elements in the PBCH with subcarrier number k is set to zero, the set of resource elements is in one or more resource blocks, and wherein k is relative to a start of the SS/PBCH block and k is in a range from 0 to a first predetermined number and/or a range from a second predetermined number to a total number of subcarriers in the PBCH.

In a fifth aspect, there is provided a method for communication. The method comprises determining that a communication between the terminal device and a network device is operating on a dedicated spectrum of which bandwidth is less than a predetermined bandwidth; and receiving, from the network device, a synchronization signal/physical broadcast channel (SS/PBCH) block on a PBCH, and wherein a set of resource elements in the PBCH with subcarrier number k is set to zero, the set of resource elements is in one or more resource blocks, and wherein k is relative to a start of the SS/PBCH block and k is in a range from 0 to a first predetermined number and/or a range from a second predetermined number to a total number of subcarriers in the PBCH.

In a sixth aspect, there is provided a method for communication. The method comprises determining that a communication between the terminal device and a network device is operating on a dedicated spectrum of which bandwidth is less than a predetermined bandwidth; receiving, from the network device, a synchronization signal/physical broadcast channel (SS/PBCH) block on a PBCH; and determine a subcarrier offset from a first subcarrier in a common resource block to a first subcarrier of the SS/PBCH block, and wherein an offset between the common resource block and the SS/PBCH block is defined associated with a value of the subcarrier offset.

In a seventh aspect, there is provided a method for communication. The method comprises: determining that a communication between the terminal device and a network device is operating on a dedicated spectrum of which bandwidth is less than a predetermined bandwidth; and determining a subset of resource blocks from a control resource set, and wherein physical downlink control channel (PDCCH) and corresponding demodulation reference signal (DMRS) resource elements of a resource element group with a resource block outside the subset of resource blocks are set to zero.

In an eighth aspect, there is provided a method for communication. The method comprises determining that a communication between a terminal device and the network device is operating on a dedicated spectrum of which bandwidth is less than a predetermined bandwidth; and transmitting, to the terminal device, a synchronization signal/physical broadcast channel (SS/PBCH) block on a PBCH, and wherein a set of resource elements in the PBCH with subcarrier number k is set to zero, the set of resource elements is in one or more resource blocks, and wherein k is relative to a start of the SS/PBCH block and k is in a range from 0 to a first predetermined number and/or a range from a second predetermined number to a total number of subcarriers in the PBCH.

In a ninth aspect, there is provided a computer readable medium having instructions stored thereon, the instructions, when executed on at least one processor, causing the at least one processor to carry out the method according to the fifth, sixth, seventh, or eighth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIGS. 1A and 1B are schematic diagrams of subcarrier offsets, respectively;

FIG. 2 illustrates a schematic diagram of physical broadcast channel (PBCH) and physical downlink shared channel (PDSCH);

FIG. 3 illustrates a schematic diagram of a communication environment in which embodiments of the present disclosure can be implemented;

FIG. 4A illustrates a signaling flow for communications according to some embodiments of the present disclosure;

FIG. 4B illustrates a signaling flow for communications according to some other embodiments of the present disclosure;

FIGS. 5A and 5B are schematic diagrams of channels according to some other embodiments of the present disclosure, respectively;

FIGS. 6A and 6B are schematic diagrams of subcarrier offsets according to some other embodiments of the present disclosure, respectively;

FIG. 7 is a flowchart of an example method in accordance with an embodiment of the present disclosure;

FIG. 8 is a flowchart of an example method in accordance with an embodiment of the present disclosure;

FIG. 9 is a flowchart of an example method in accordance with an embodiment of the present disclosure;

FIG. 10 is a flowchart of an example method in accordance with an embodiment of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “bandwidth part (BWP)” used herein may refer to a set of attached Common Resource Blocks. A Bandwidth Part may include all Common Resource Blocks within the channel bandwidth, or a subset of Common Resource Blocks. BWP may be a part of the total channel bandwidth configured for a cell that is used for a UE at a specific moment of operation. The term “bitwidth” may refer to the number of bits of a field. The term “bitwidth” may be interchanged with the term “payload size.”

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. The term “dedicated spectrum” used herein may refer to a spectrum including frequency domain resources that is specific to a device. The term “physical broadcast channel (PBCH)” used herein may refer to a channel that broadcasts a limited number of parameters essential for initial access of a cell, such as, downlink system bandwidth and the like. The term “control resource set (CORESET)” used herein may refer to physical resources that is designed to transmit physical downlink control channel (PDCCH)/downlink control information (DCI). The CORESET may be defined as a set of resource element groups (REGs) under given numerology (i.e., subcarrier spacing). The term “Type 0 PDCCH Common Search Space (CSS)” used herein may refer to a subset of NR PDCCH Search Space that is dedicated to transmit the PDCCH for SI message (i.e., SIB1). The term “PDCCH Search Space” used herein may refer to the area in the downlink resource grid where PDCCH may be carried. Type OA PDCCH CSS may be used for monitoring other SIBs.

As mentioned above, further studies on dedicated spectrums are needed. For example, in some solutions, it can support the dedicated spectrum with 5 MHz bandwidth. For the dedicated spectrum with 5 MHz bandwidth, there may be 20 resource blocks on a physical broadcast channel (PBCH). Control resource set (CORESET) #0 may have minimum 24 resource blocks. CORESET #0 can be used for monitoring downlink control information (DCI) scheduling system information block 1 (SIB1) physical downlink shared channel (PDSCH). After receiving SIB1, BWP which is less than 5 MHz can be configured for UE for the later transmission and reception. Therefore, PBCH and CORESET #0 before receiving SIB1 may be enhanced to support the initial access of UE on the dedicated spectrum less than 5 MHz.

Moreover, the dedicated spectrum with bandwidth less than 5 MHz are under studying. For example, the objectives may include: identify and specify necessary changes to NR physical layer with minimum specification impact to operate in spectrum allocations from approximately 3 MHz up to below 5 MHz; restrict to subcarrier spacing of 15 kHz and the use of normal cyclic prefix; reuse primary synchronization signal (PSS)/secondary synchronization signal (SSS) specification without puncturing; PBCH based on current design; identify and specify necessary minimum changes to physical downlink control channel (PDCCH), channel state information-reference signal (CSI-RS)/tracking reference signal (TRS), physical uplink control channel (PUCCH), and physical random access channel (PRACH) for functional support based on existing design, without optimization.

In some solutions, in addition to reuse 5 MHz channel bandwidth, it also supposes that only 3 MHz channel bandwidth is supported. Moreover, it may assume maximum transmission bandwidth, 15RBs or 16RBs for 3 MHz channel BW for evaluation and analysis. For transmission bandwidth [s] of <5 MHz, for PBCH, in the case that available PRBs for PBCH transmission is less than 20PRB, PBCH may be based on RB-level puncturing, i.e., PBCH encoding is based on 20PRB. The encoded bits and DMRS are mapped to 20PRBs based on legacy SSB structure, and those PRBs that fall outside of available PRBs for PBCH transmission are punctured.

In some solutions, for CORESET #0 configuration for transmission bandwidths <5 MHz for 3 MHz and 5 MHz channel bandwidth, following options are for study: Opt.1: existing configuration table for 15 kHz subcarrier spacing (SCS), 5 MHz minimum channel BW is reused for configuration; Opt.2: a new CORESET #0 configuration table is to be introduced for the configuration. Moreover, it also needs to study whether and how to recover physical downlink control channel (PDCCH) detection performance of CORESET #0 for transmission bandwidths of <5 MHz for 3 MHz and 5 MHz channel bandwidth. The following options are considered: Opt.1: power boosting; Opt.2: non-interleaved CCE-to-REG mapping; Opt.3: a new interleaver to ensure PDCCH is fully mapped in the spectrum; Opt.4: new aggregation level(s) for fit in the spectrum; Opt.5: PDCCH rate matching; or Opt.6.: no enhancement specified.

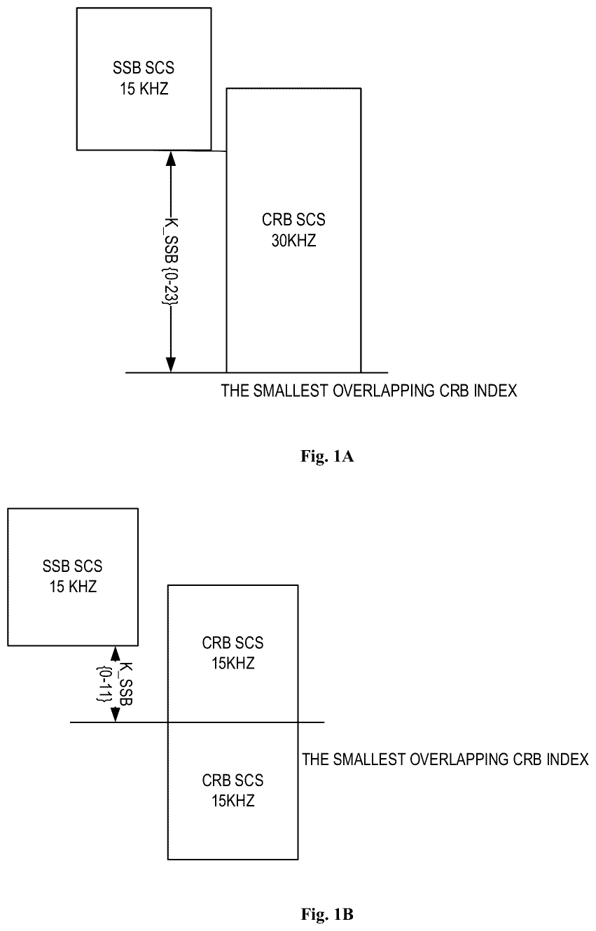

In some solutions, UE may assume that the complex-valued symbols corresponding to resource elements that are part of a common resource block partially or fully overlapping with an SS/PBCH block and not used for SS/PBCH transmission are set to zero in the OFDM symbols partially or fully overlapping with OFDM symbols where SS/PBCH is transmitted. In some other solutions, the offset is defined with respect to the SCS of the CORESET for Type0-PDCCH CSS set, provided by subCarrierSpacingCommon, from the smallest RB index of the CORESET for Type0-PDCCH CSS set to the smallest RB index of the common RB overlapping with the first RB of the corresponding SS/PBCH block. For example, as shown in FIG. 1A, if the SSB SCS is 15 kHz and the common resource block (CRB) SCS is 30 kHz, the offset may be in a range from 0 to 23. As shown in FIG. 1B, if the SSB SCS is 15 kHz and the CRB SCS is 15 kHz, the offset may be in a range from 0 to 11.

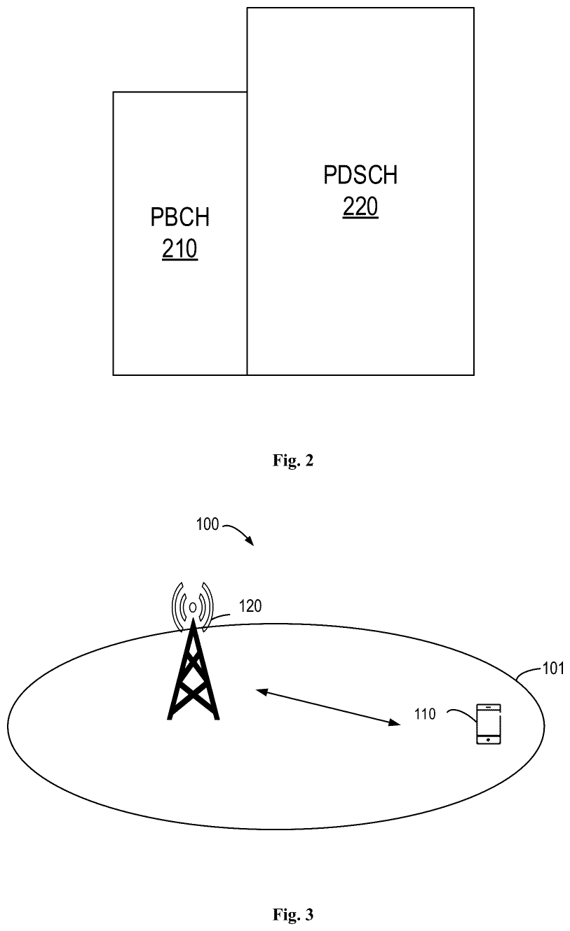

Furthermore, the UE may assume SS/PBCH block transmission according to ssb-PositionsInBurst if the PDSCH resource allocation overlaps with PRBs containing SS/PBCH block transmission resources, the UE may assume that the PRBs containing SS/PBCH block transmission resources are not available for PDSCH in the Orthogonal frequency-division multiplexing (OFDM) symbols where SS/PBCH block is transmitted. For example, as shown in FIG. 2, the UE may assume that that the PRBs containing SS/PBCH block 210 transmission resources are not available for PDSCH 220 in the OFDM symbols where SS/PBCH block is transmitted.

In order to solve at least part of the above problems or other potential problems, solutions on dedicated spectrum are proposed. Embodiments of the present disclosure are related to PBCH and CORESET #0 configuration and behaviour for operation on dedicated spectrum less than 5 MHz. A terminal device determines that a communication between the terminal device and a network device is operating on a dedicated spectrum of which bandwidth is less than a predetermined bandwidth. The network device transmits a SSB on a PBCH to the terminal device. A set of resource elements in the PBCH with subcarrier number k is set to zero, the set of resource elements is in one or more resource blocks, and k is relative to a start of the SS/PBCH block and k is in a range from 0 to a first predetermined number and/or a range from a second predetermined number to a total number of subcarriers in the PBCH. In this way, it can save resources by reusing the resources.

Principles and implementations of the present disclosure will be described in detail below with reference to the figures.

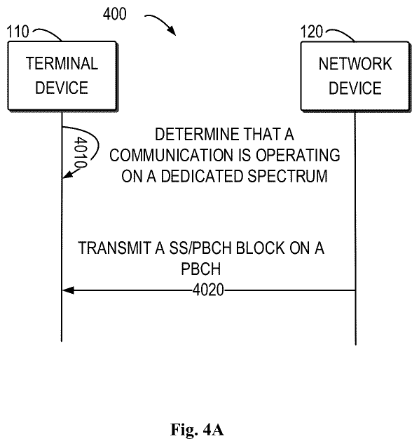

FIG. 3 illustrates a schematic diagram of an example communication network 100 in which some embodiments of the present disclosure can be implemented. As shown in FIG. 3, the communication network 100 may include a terminal device 110 and a network device 120. The network device 120 may provide a cell 101 to serve one or more terminal devices.

In this example, the terminal device 110 is located in the cell 101 and is served by the network device 120. It is noted that the network device 120 may provide a proper number of cells to serve the terminal devices.

It is to be understood that the number of devices and cells in FIG. 3 is given for the purpose of illustration without suggesting any limitations to the present disclosure. The communication network 100 may include any suitable number of network devices and/or terminal devices and/or cells adapted for implementing implementations of the present disclosure.

In some embodiments, the terminal device 110 and the network device 120 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “slot” used herein refers to a dynamic scheduling unit. One slot comprises a predetermined number of symbols. The slot used herein may refer to a normal slot which comprises a predetermined number of symbols and also refer to a sub-slot which comprises fewer symbols than the predetermined number of symbols.

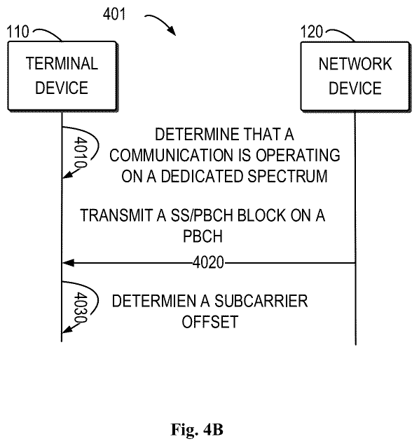

Reference is first made to FIG. 4A, which illustrates a signaling chart illustrating process 400 among the terminal device and the network device according to some example embodiments of the present disclosure. FIG. 4B illustrates a signaling chart illustrating process 401 among the terminal device and the network device according to some example embodiments of the present disclosure. Only for the purpose of discussion, the processes 400 and 401 will be described with reference to FIG. 3. For example, the processes 400 and 401 may involve the terminal device 110 and the network device 120.

As shown in FIGS. 4A and 4B, the terminal device 110 determines (4010) that a communication between the terminal device 110 and the network device 120 is operating on a dedicated spectrum of which bandwidth is less than a predetermined bandwidth. In some embodiments, the predetermined bandwidth may be 5 MHz. It is noted that the predetermined bandwidth may be any suitable bandwidths.

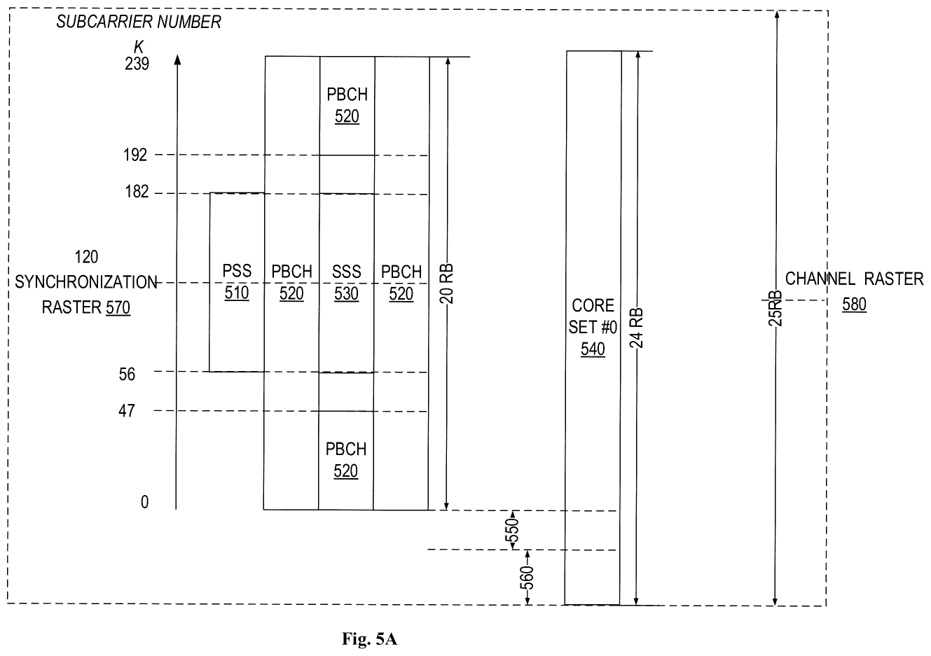

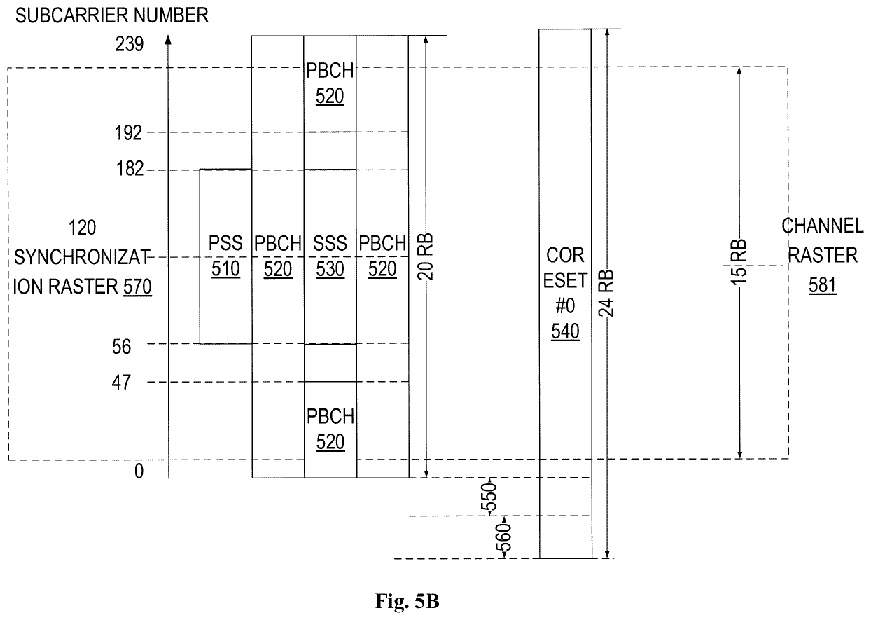

In some embodiments, if the terminal device 110 detects PSS/SSS on a dedicated synchronization raster which is different from a global synchronization raster, the terminal device 110 may determine that the communication is operated on the dedicated spectrum with the bandwidth less than the predetermined bandwidth. For example, shown in FIG. 5A, the 5 MHz channel may include 25 resource blocks and have a channel raster 580 which is in the middle of total number (i.e., 25) of resource blocks that are allocated in the channel. The terminal device 110 may detect PSS 510/SSS 530 on the synchronization raster 570 which is difference from the channel raster 580. Thus, the terminal device 110 may determine that the communication is operated on the dedicated spectrum with the bandwidth less than the predetermined bandwidth. As shown in FIG. 5B, the 3 MHz channel may include 15 resource blocks and have a channel raster 581 which is in the middle of total number (i.e., 15) of resource blocks that are allocated in the channel. The terminal device 110 may detect PSS 510/SSS 530 on the synchronization raster 570 which is different from the channel raster 581. In this case, the terminal device 110 may determine that the communication is operated on the dedicated spectrum with the bandwidth less than the predetermined bandwidth.

The network device 120 transmits (4020) a SS/PBCH block on a PBCH to the terminal device 110. For example, as shown in FIGS. 5A and 5B, the total number of subcarriers in the PBCH 520 may be 240. Embodiments of punctured PBCH assumption and corresponding PDSCH puncturing are described later.

A set of resource elements in the PBCH with subcarrier number k is set to zero and the set of resource elements is in one or more resource blocks. In this case, k is relative to a start of the SS/PBCH block and k is in a range from 0 to a first predetermined number and/or a range from a second predetermined number to a total number of subcarriers in the PBCH. For example, when 0<=k<=a and b<=k<=239, resource elements in some PRB in PBCH with subcarrier number k may be set to zero. Parameters a and b may represent a resource element index. For example, a may be one of: 12, 24, or 36.

In some embodiments, symbols corresponding to resource elements that are part of a common resource block at least partially overlapping with an actual SS/PBCH block and not used for SS/PBCH transmission are set to zero in Orthogonal Frequency Division Multiplexing (OFDM) symbols that are at least partially overlapping with OFDM symbols where the SS/PBCH block is transmitted. The actual SS/PBCH block may include resources of the SS/PBCH block with subcarrier number k from the first predetermined number plus 1 to the second predetermined number minus 1. In some embodiments, if a physical downlink shared channel (PDSCH) resource allocation overlaps with one or more resource blocks including resources of the actual SS/PBCH block, the one or more resource blocks including the resources of the actual SS/PBCH block are not available PDSCH in the OFDM symbols where the SS/PBCH block is transmitted.

By way of example, the SS/PBCH block is called nominal SSB and set of SS/PBCH block that subcarrier number k from a+1 to b−1 is call actual SSB. In this case, the terminal device 110 may assume that the complex-valued symbols corresponding to resource elements that are part of a common resource block partially or fully overlapping with an actual SS/PBCH block and not used for SS/PBCH transmission are set to zero in the OFDM symbols partially or fully overlapping with OFDM symbols where SS/PBCH is transmitted.

In some embodiments, the terminal device 110 may receive one or more RRC parameters for SSB sequence and SSB interval in a RRC message. For example, the RRC parameter may include ssb-PositionsInBurst that indicates time domain position of SSB in a SSB burst. The first left most bit corresponds to SS/PBCH index 0, the second left most bit corresponds to SS/PBCH index 1 and so on. In this case, the terminal device 110 may further assume SS/PBCH block transmission according to ssb-PositionsInBurst if the PDSCH resource allocation overlaps with PRBs containing actual SS/PBCH block transmission resources, the terminal device 110 may assume that the PRBs containing actual SS/PBCH block transmission resources are not available for PDSCH in the OFDM symbols where SS/PBCH block is transmitted. In other words, if the available number of resource block is larger than 15 and less than 20 (for example, 18 resource blocks), it always assumes PRB will be used to transmit SSB regardless of the number of RB for the dedicated spectrum. As resources of SS/PBCH block outside actual SSB are set to zero from SS/PBCH block's perspective, PDSCH can reuse those resources and only resources of PDSCH overlaps with actual SSB cannot be used.

Alternatively, if 0<=k<=(12*a-1) and 12*b<=k<=239, resource elements in some PRB in PBCH with subcarrier number k may or can be set to zero. In this case, k is relative to the start of an SS/PBCH block, 0<=a<=a_max, b_min<=b<=20, a_max and b_min are predefined values. For example, values of a and b may be determined by the network device 120. In some embodiments, the terminal device 110 may know the values of a and b by detecting whether PBCH signal exists on those resource blocks. Alternatively, the terminal device 110 may know the values of a and b and whether set to zero or not by some prior information provided on that dedicated spectrum, for example, information stored in Subscriber Identity Module (SIM) card. In this situation, if the available number of resource blocks is larger than 15 and less than 20 (for example, 18 resource blocks), it allows PBCH to transmit on 18 PRB which could increase PBCH performance. For capability disabled UE, it can detect PBCH on 15 resource block which can be make sure that resource elements are not set to zero. For capability enabled UE, it can firstly detect the PRB available/used for PBCH and then detect PBCH. In this way, it can be more flexible.

As shown in FIG. 5A and FIG. 5B, the subcarrier level offset 550 is determined by k_SSB indicated in PBCH payload and the RB level offset 560 is determined by CORSET #0 configuration in master information block (MIB). For example, the MIB may include a subCarrierSpacingCommon that indicates the Subcarrier spacing for SIB1, Msg.2/4 for initial access and SI-messages. Examples of this value varies with frequency range are shown in Table 1.

TABLE 1

| | SCS 15 or 60 kHz | SCS 30 or 120 kHz |
|---|---|---|
| FR1 | 15 kHz | 30 kHz |
| FR2 | 60 kHz | 120 kHz |

Exampled embodiments of k_SSB indicating larger of subcarrier offset are described below.

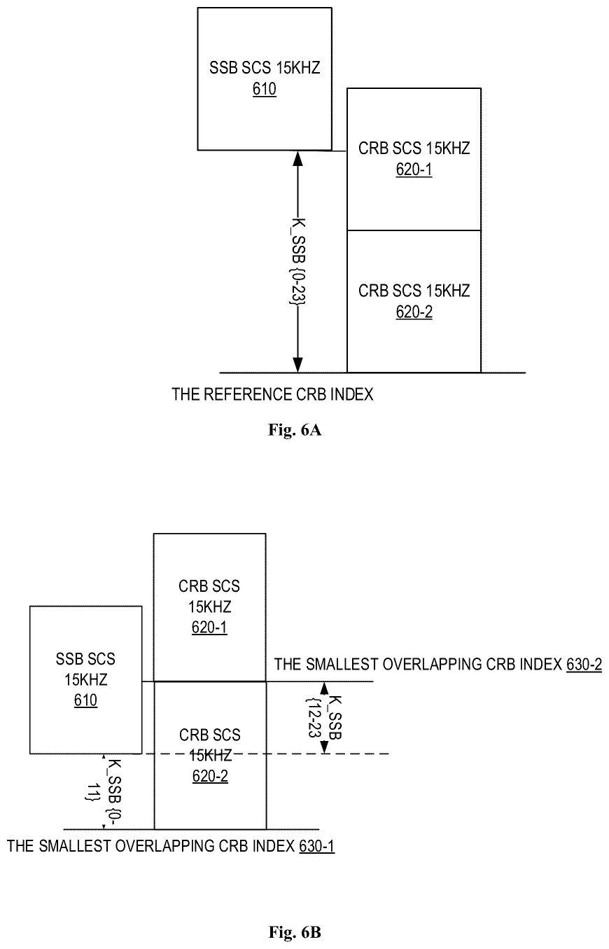

In some embodiments, the quantity k_SSB is the subcarrier offset from subcarrier 0 in common resource block N∧CRB_SSB to subcarrier 0 of the SS/PBCH block. The offset may be defined with respect to the SCS of the CORESET for Type0-PDCCH CSS set, provided by subCarrierSpacingCommon, from the smallest RB index of the CORESET for Type0-PDCCH CSS set to common resource block N∧CRB_SSB+A. For example, A can be any one of 0, 1, 2, or 3. By way of example, as shown in FIG. 6A, the offset may be defined with respect to the SCS of the CORESET for Type0-PDCCH CSS set, from the smallest RB index of the CORESET for Type0-PDCCH CSS set to common resource block 620-2+A. In this case, A may be 0 or 1.

As shown in FIG. 4B, the terminal device 110 determines (4030) a subcarrier offset from a first subcarrier in a common resource block to a first subcarrier of the SS/PBCH block. An offset between the common resource block and the SS/PBCH block may be defined associated with a value of the subcarrier offset. In this way, since the subcarrier offset between 12 to 23 is not needed when SCS of SSB and CORESET #0 are both 15 KHz, it can be used to further indicate the RB level offset for finer offset indication.

In some embodiments, if the subcarrier offset is in a range from 0 to a first predetermined number, the offset may be defined with respect to a subcarrier spacing (SCS) of a control resource set (CORESET), from a smallest resource block index of the CORESET to a smallest resource index of the common RB overlapping with a reference resource block of the SS/PBCH block. For example, if k_SSB<12, the offset is defined with respect to the SCS of the CORESET for Type0-PDCCH CSS set, provided by subCarrierSpacingCommon, from the smallest RB index of the CORESET for Type0-PDCCH CSS set to the smallest RB index of the common RB overlapping with the reference RB of the corresponding SS/PBCH block. By way of example, as shown in FIG. 6B, if k_SSB<12, the offset is defined with respect to the SCS of the CORESET for Type0-PDCCH CSS set, from the smallest RB index of the CORESET for Type0-PDCCH CSS set to the smallest RB index 630-1 of the common RB overlapping with the reference RB of the corresponding SS/PBCH block.

Alternatively, if the subcarrier offset is in a range from a second predetermined number to a third predetermined number, the offset may be defined with respect to the SCS of the CORESET, from the smallest resource block index of the CORESET for Type0-PDCCH CSS set to the smallest resource block index of the common RB overlapping with the reference resource block of the SS/PBCH block plus one. For example, if 12<=k_SSB<24, the offset is defined with respect to the SCS of the CORESET for Type0-PDCCH CSS set, provided by subCarrierSpacingCommon, from the smallest RB index of the CORESET for Type0-PDCCH CSS set to the smallest RB index of the common RB overlapping with the reference RB of the corresponding SS/PBCH block plus one. By way of example, as shown in FIG. 6B, if 12<=k_SSB<24, the offset is defined with respect to the SCS of the CORESET for Type0-PDCCH CSS set from the smallest RB index of the CORESET for Type0-PDCCH CSS set to the smallest RB index 630-2 of the common RB overlapping with the reference RB of the corresponding SS/PBCH block plus one.

In some embodiments, the reference resource block may be a first resource block of the SS/PBCH block. Alternatively, the reference resource block may be a third resource block of the SS/PBCH block.

Example embodiments of available resource block determination in CORESET #0are described later. In some embodiments, the network device 120 transmits PDCCH to the terminal device 110 using Resource Elements (REs) within a Control Resource Set (CORESET). For each DL BWP configured to the terminal device 110 in a serving cell, the terminal device 110 can be provided by higher layer signalling with P≤3 CORESETs. For each CORESET, the terminal device 110 may be provided at least one of the following parameters by ControlResourceSet: controlResourceSetId, frequencyDomainResources, duration, cce-REG-MappingType, a precoderGranularity, tci-StatesPDCCH-ToAddList, tci-StatesPDCCH-ToReleaseList, tci-PresentInDCI, or pdcch-DMRS-ScramblingID. For example, the frequencyDomainResources may indicate a set of resource blocks and each bit corresponds a group of 6 RBs. The duration may indicate contiguous time duration of the CORESET in number of symbols. The cce-REG-MappingType may indicate number of REGs bundled together. When cce-REG-MappingType is absent, the terminal device 110 may use a physical cell ID. The precoderGranularity may indicate precoder granularity in frequency domain and have the value same as REG-bundle or all contiguous RBs. The tci-StatesPDCCH-ToAddList and/or tci-StatesPDCCH-ToReleaseList may indicate a subset of the TCI states defined in pdsch-Config. If the field “tci-PresentInDCI” is present, it means that TCI field is present in DL-related DCI. If the field “tci-PresentInDCI” is absent: it means that TCI field is absent in DL-related DCI. The pdcch-DMRS-ScramblingID may indicate DM-RS scrambling sequence initialization value. When the pdcch-DMRS-ScramblingID, the terminal device 110 may use physCellId.

The terminal device 110 determines a subset of resource blocks from a control resource set. In this case, physical downlink control channel (PDCCH) and corresponding demodulation reference signal (DMRS) resource elements of a resource element group with a resource block outside the subset of resource blocks are set to zero. For example, the control resource set comprises 24 resource blocks. In some embodiments, the set of resource block may include a plurality of contiguous resource blocks starting from index 0. In some embodiments, if a parameter equal to all contiguous resource blocks, the PDCCH and the DMRS may be mapping in all resource element groups within the subset of resource blocks where the terminal device decodes a physical downlink control channel. In this way, it has less impact on PDCCH CCE index determination.

By way of example, the bandwidth of (the number of PRB in) CORESET #0 (CORESET for Type0-PDCCH CSS) is fixed to 24 RB. Subset A of CORESET #0 (CORESET for Type0-PDCCH CSS) are configured/defined. Subset A includes contiguous RB starting from RB index 0. PDCCH and corresponding DMRS resource elements of a REG with corresponding PRB outside the subset A of CORESET #0 are set to zero. PDCCH DMRS are mapping in all resource-element groups within the subset A of in the CORESET #0 where the terminal device attempts to decode the PDCCH if the higher-layer parameter precoderGranularity equals allContiguousRBs. In this case, since a REG bundle in CORESET #0 has 6 REG, the number of RB in CORESET #0should be multiple of 6 to determine CCE index based on the current behavior. Keeping BW of CORESET #0 fixed to 24 has less impact on existing PDCCH CCE index determination.

In some embodiments, the terminal device 110 may determine a field length of frequency domain resource assignment for downlink control information based on a size of the subset of resource blocks. In other words, field length of frequency domain resource assignment for DCI format 1_0 is determined based on the available size of CORESET #0, i.e. size of subset A, if CORESET #0 is configured for the cell. In this way, it can reduce the payload size of DCI format 1_0 which can be used to compensate the performance loss due to some resources are set to zero in PDCCH. DCI Format 1_0 may be typically used for scheduling PDSCH to a UE in a cell.

In some embodiments, the number of resource blocks in the subset is indicated in a control resource set configuration. For example, the number of RB in subset A may be indicated in CORESET #0 configuration in MIB. By way of example, some consideration on offset value design in Table 2.

TABLE 2

| | multiplexing | Number | Number of | Number of | Offset 1 | Offset 2 |
|---|---|---|---|---|---|---|
| Index | pattern | of RBs | Symbols | available | (RBs) | (RBs) |
| 0 | 1 | 24 | 2 | 15 | 0 | 0 |
| 1 | 1 | 24 | 2 | 15 | −2 | −1 |
| 2 | 1 | 24 | 3 | 15 | 0 | 0 |
| 3 | 1 | 24 | 3 | 15 | −2 | −1 |
| 4 | 1 | 24 | 2 | 18 | 0 | 0 |
| 5 | 1 | 24 | 2 | 18 | 2 | 1 |
| 6 | 1 | 24 | 3 | 18 | 0 | 0 |
| 7 | 1 | 24 | 3 | 18 | 2 | 1 |
| 8 | 1 | 24 | 2 | 21 | 0 | 0 |
| 9 | 1 | 24 | 2 | 21 | 2 | 1 |
| 10 | 1 | 24 | 2 | 21 | 4 | 2 |
| 11 | 1 | 24 | 3 | 21 | 0 | 0 |
| 12 | 1 | 24 | 3 | 21 | 2 | 1 |
| 13 | 1 | 24 | 3 | 21 | 4 | 2 |
| 14 | Reserved | | | | | |
| 15 | | | | | | |

As shown in Table 1, offset 1 is applied for adopting finer offset indication by k_SSB (case 2), because k_SSB can indicate the offset within 2 RB, so the RB level offset could be multiple of 2. Offset 2 is applied for adopting finer offset indication. For 15 available RB, since k_SSB can indicate positive offset of CORESET #0 and SSB, i.e. low edge of CORESET #0 is lower than low edge of SSB, −1 can be introduced to indicate negative offset, i.e. low edge of CORESET #0 is larger than low edge of SSB. Since 15 available RB implies the bandwidth on dedicated spectrum is about 3 MHz, only 0 and/or −1 is needed, no other offset value is needed. For other available RB value larger than 15, since CORESET #0 is larger than SSB, the RB level offset could also be positive value, negative value is this case is not needed.

In some embodiments, the subset of resource blocks comprises 15 resource blocks. Alternatively, the subset of resource blocks comprises resource blocks from a first index to a second index that has a largest resource block index of the control resource set overlapping with a resource block of the SS/PBCH block. For example, the resource block of the SS/PBCH block is a last resource block of the SS/PBCH block. In other words, subset A includes RB from index 0 to index that has the largest RB index of the CORESET for Type0-PDCCH CSS set (fully) overlapping with (any/last) RB of the corresponding SS/PBCH block.

It is noted that above-described embodiments described can be implemented in any combinations. Alternatively, above-described embodiments can be implemented separately. The present disclosure is not limited in this aspect.

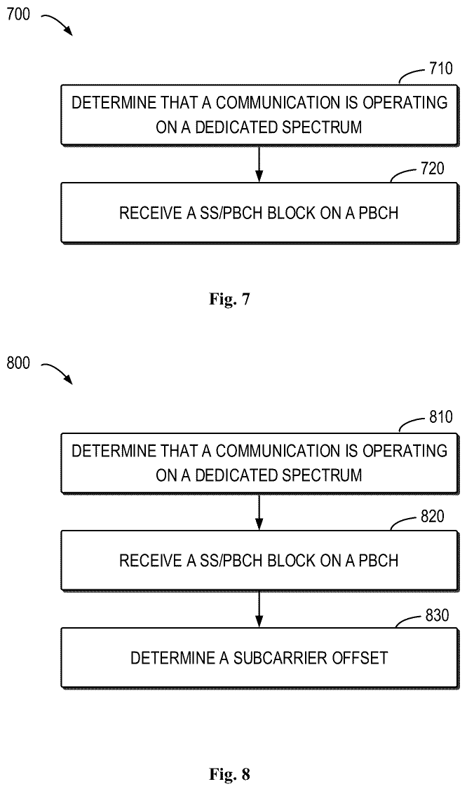

FIG. 7 shows a flowchart of an example method 700 in accordance with an embodiment of the present disclosure. The method 700 can be implemented at any suitable terminal devices. Only for the purpose of illustrations, the method 700 can be implemented at a terminal device 110 as shown in FIG. 1.

At block 710, the terminal device 110 determines that a communication between the terminal device and a network device is operating on a dedicated spectrum of which bandwidth is less than a predetermined bandwidth. The predetermined bandwidth may be 5 MHz.

At block 720, the terminal device 110 receives, from the network device 120, a synchronization signal/physical broadcast channel (SS/PBCH) block on a PBCH. In this case, a set of resource elements in the PBCH with subcarrier number k is set to zero, the set of resource elements is in one or more resource blocks, and k is relative to a start of the SS/PBCH block and k is in a range from 0 to a first predetermined number and/or a range from a second predetermined number to a total number of subcarriers in the PBCH. The total number of subcarriers in the PBCH may be 240.

In some embodiments, symbols corresponding to resource elements that are part of a common resource block at least partially overlapping with an actual SS/PBCH block and not used for SS/PBCH transmission are set to zero in Orthogonal Frequency Division Multiplexing (OFDM) symbols that are at least partially overlapping with OFDM symbols where the SS/PBCH block is transmitted. In some embodiments, the actual SS/PBCH block comprises resources of the SS/PBCH block with subcarrier number k from the first predetermined number plus 1 to the second predetermined number minus 1.

In some embodiments, if a physical downlink shared channel (PDSCH) resource allocation overlaps with one or more resource blocks including resources of the actual SS/PBCH block, the one or more resource blocks including the resources of the actual SS/PBCH block are not available PDSCH in the OFDM symbols where the SS/PBCH block is transmitted.

FIG. 8 shows a flowchart of an example method 800 in accordance with an embodiment of the present disclosure. The method 800 can be implemented at any suitable terminal devices. Only for the purpose of illustrations, the method 800 can be implemented at a terminal device 110 as shown in FIG. 1.

At block 810, the terminal device 110 determines that a communication between the terminal device and a network device is operating on a dedicated spectrum of which bandwidth is less than a predetermined bandwidth. The predetermined bandwidth may be 5 MHz.

At block 820, the terminal device 110 receives, from the network device 120, a synchronization signal/physical broadcast channel (SS/PBCH) block on a PBCH. The total number of subcarriers in the PBCH may be 240.

At block 830, the terminal device 110 determines a subcarrier offset from a first subcarrier in a common resource block to a first subcarrier of the SS/PBCH block. An offset between the common resource block and the SS/PBCH block is defined associated with a value of the subcarrier offset.

In some embodiments, if the subcarrier offset is in a range from 0 to a first predetermined number, the offset is defined with respect to a subcarrier spacing (SCS) of a control resource set (CORESET), from a smallest resource block index of the CORESET to a smallest resource index of the common RB overlapping with a reference resource block of the SS/PBCH block. Alternatively, if the subcarrier offset is in a range from a second predetermined number to a third predetermined number, the offset is defined with respect to the SCS of the CORESET, from the smallest resource block index of the CORESET for Type0-PDCCH CSS set to the smallest resource block index of the common RB overlapping with the reference resource block of the SS/PBCH block plus one.

In some embodiments, the reference resource block is a first resource block of the SS/PBCH block. Alternatively, the reference resource block is a third resource block of the SS/PBCH block.

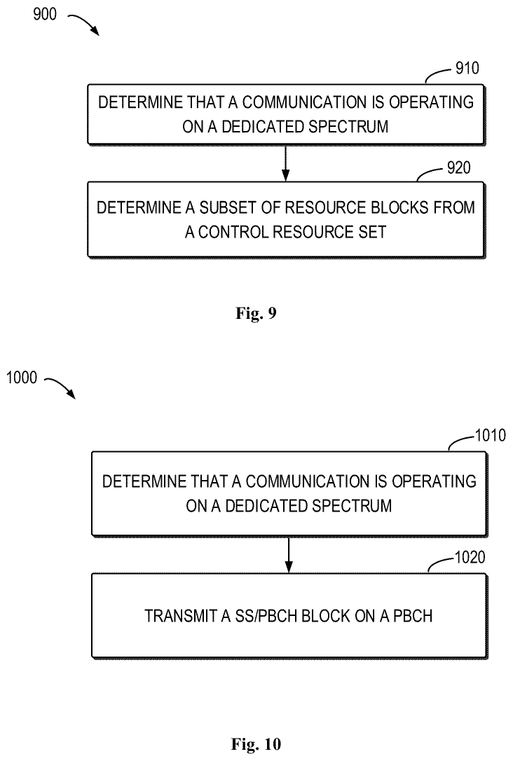

FIG. 9 shows a flowchart of an example method 900 in accordance with an embodiment of the present disclosure. The method 900 can be implemented at any suitable terminal devices. Only for the purpose of illustrations, the method 900 can be implemented at a terminal device 110 as shown in FIG. 1.

At block 910, the terminal device 110 determines that a communication between the terminal device and a network device is operating on a dedicated spectrum of which bandwidth is less than a predetermined bandwidth. The predetermined bandwidth may be 5 MHz.

At block 920, the terminal device 110 determines a subset of resource blocks from a control resource set. In this case, physical downlink control channel (PDCCH) and corresponding demodulation reference signal (DMRS) resource elements of a resource element group with a resource block outside the subset of resource blocks are set to zero.

In some embodiments, the control resource set comprises 24 resource blocks. In some embodiments, the set of resource block comprises a plurality of contiguous resource blocks starting from index 0. In some embodiments, if a parameter equal to all contiguous resource blocks, the PDCCH and the DMRS are mapping in all resource element groups within the subset of resource blocks where the terminal device decodes a physical downlink control channel.

In some embodiments, the terminal device 110 may determine a field length of frequency domain resource assignment for downlink control information based on a size of the subset of resource blocks. In some embodiments, the number of resource blocks in the subset is indicated in a control resource set configuration. In some embodiments, the subset of resource blocks comprises 15 resource blocks. In some embodiments, the subset of resource blocks comprises resource blocks from a first index to a second index that has a largest resource block index of the control resource set overlapping with a resource block of the SS/PBCH block. In some embodiments, the resource block of the SS/PBCH block is a last resource block of the SS/PBCH block.

FIG. 10 shows a flowchart of an example method 1000 in accordance with an embodiment of the present disclosure. The method 1000 can be implemented at any suitable terminal devices. Only for the purpose of illustrations, the method 1000 can be implemented at a network device 120 as shown in FIG. 1.

At block 1010, the network device 120 determines that a communication between a terminal device and the network device is operating on a dedicated spectrum of which bandwidth is less than a predetermined bandwidth. The predetermined bandwidth may be 5 MHz.

At block 1020, the network device 120 transmits, to the terminal device 110, a synchronization signal/physical broadcast channel (SS/PBCH) block on a PBCH. In this case, a set of resource elements in the PBCH with subcarrier number k is set to zero, the set of resource elements is in one or more resource blocks, k is relative to a start of the SS/PBCH block and k is in a range from 0 to a first predetermined number and/or a range from a second predetermined number to a total number of subcarriers in the PBCH. In some embodiments, the total number of subcarriers in the PBCH is 240.

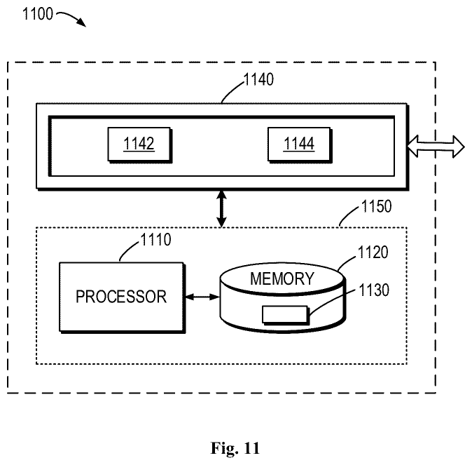

FIG. 11 is a simplified block diagram of a device 1100 that is suitable for implementing embodiments of the present disclosure. The device 1100 can be considered as a further example implementation of the terminal device 110 or the network device 120 as shown in FIG. 1. Accordingly, the device 1100 can be implemented at or as at least a part of the terminal device 110 or the network device 120.

As shown, the device 1100 includes a processor 1110, a memory 1120 coupled to the processor 1110, a suitable transceiver 1140 coupled to the processor 1110, and a communication interface coupled to the transceiver 1140. The memory 1110 stores at least a part of a program 1130. The transceiver 1140 may be for bidirectional communications or a unidirectional communication based on requirements. The transceiver 1140 may include at least one of a transmitter 1142 and a receiver 1144. The transmitter 1142 and the receiver 1144 may be functional modules or physical entities. The transceiver 1140 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1130 is assumed to include program instructions that, when executed by the associated processor 1110, enable the device 1100 to operate in accordance with the embodiments of the present disclosure, as discussed herein with reference to FIGS. 1 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

In some embodiments, a terminal device comprises a circuitry configured to: determine that a communication between the terminal device and a network device is operating on a dedicated spectrum of which bandwidth is less than a predetermined bandwidth; and receive, from the network device, a synchronization signal/physical broadcast channel (SS/PBCH) block on a PBCH, and wherein a set of resource elements in the PBCH with subcarrier number k is set to zero, the set of resource elements is in one or more resource blocks, and wherein k is relative to a start of the SS/PBCH block and k is in a range from 0 to a first predetermined number and/or a range from a second predetermined number to a total number of subcarriers in the PBCH.

In some embodiments, a terminal device comprises a circuitry configured to: determine that a communication between the terminal device and a network device is operating on a dedicated spectrum of which bandwidth is less than a predetermined bandwidth; receive, from the network device, a synchronization signal/physical broadcast channel (SS/PBCH) block on a PBCH; and determine a subcarrier offset from a first subcarrier in a common resource block to a first subcarrier of the SS/PBCH block, and wherein an offset between the common resource block and the SS/PBCH block is defined associated with a value of the subcarrier offset.

In some embodiments, a terminal device comprises a circuitry configured to: determine that a communication between the terminal device and a network device is operating on a dedicated spectrum of which bandwidth is less than a predetermined bandwidth; and determine a subset of resource blocks from a control resource set, and wherein physical downlink control channel (PDCCH) and corresponding demodulation reference signal (DMRS) resource elements of a resource element group with a resource block outside the subset of resource blocks are set to zero.

In some embodiments, a network device comprises a circuitry configured to: determine that a communication between a terminal device and the network device is operating on a dedicated spectrum of which bandwidth is less than a predetermined bandwidth; and transmit, to the terminal device, a synchronization signal/physical broadcast channel (SS/PBCH) block on a PBCH, and wherein a set of resource elements in the PBCH with subcarrier number k is set to zero, the set of resource elements is in one or more resource blocks, and wherein k is relative to a start of the SS/PBCH block and k is in a range from 0 to a first predetermined number and/or a range from a second predetermined number to a total number of subcarriers in the PBCH.

According to embodiments of the present disclosure, the circuitry may be configured to perform any of the method implemented by the device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In an aspect, a terminal device, comprises a processor, configured to cause the terminal device to: determine that a communication between the terminal device and a network device is operating on a dedicated spectrum of which bandwidth is less than a predetermined bandwidth; and receive, from the network device, a synchronization signal/physical broadcast channel (SS/PBCH) block on a PBCH, and wherein a set of resource elements in the PBCH with subcarrier number k is set to zero, the set of resource elements is in one or more resource blocks, and wherein k is relative to a start of the SS/PBCH block and k is in a range from 0 to a first predetermined number and/or a range from a second predetermined number to a total number of subcarriers in the PBCH.

In some solutions, the predetermined bandwidth is 5 MHz, and the total number of subcarriers in the PBCH is 240.

In some solutions, symbols corresponding to resource elements that are part of a common resource block at least partially overlapping with an actual SS/PBCH block and not used for SS/PBCH transmission are set to zero in Orthogonal Frequency Division Multiplexing (OFDM) symbols that are at least partially overlapping with OFDM symbols where the SS/PBCH block is transmitted, and wherein the actual SS/PBCH block comprises resources of the SS/PBCH block with subcarrier number k from the first predetermined number plus 1 to the second predetermined number minus 1.

In some solutions, if a physical downlink shared channel (PDSCH) resource allocation overlaps with one or more resource blocks including resources of the actual SS/PBCH block, the one or more resource blocks including the resources of the actual SS/PBCH block are not available PDSCH in the OFDM symbols where the SS/PBCH block is transmitted.

In an aspect, a terminal device, comprises a processor, configured to cause the terminal device to: determine that a communication between the terminal device and a network device is operating on a dedicated spectrum of which bandwidth is less than a predetermined bandwidth; receive, from the network device, a synchronization signal/physical broadcast channel (SS/PBCH) block on a PBCH; and determine a subcarrier offset from a first subcarrier in a common resource block to a first subcarrier of the SS/PBCH block, and wherein an offset between the common resource block and the SS/PBCH block is defined associated with a value of the subcarrier offset.

In some solutions, if the subcarrier offset is in a range from 0 to a first predetermined number, the offset is defined with respect to a subcarrier spacing (SCS) of a control resource set (CORESET), from a smallest resource block index of the CORESET to a smallest resource index of the common RB overlapping with a reference resource block of the SS/PBCH block.

In some solutions, if the subcarrier offset is in a range from a second predetermined number to a third predetermined number, the offset is defined with respect to the SCS of the CORESET, from the smallest resource block index of the CORESET for Type0-PDCCH CSS set to the smallest resource block index of the common RB overlapping with the reference resource block of the SS/PBCH block plus one.

In some solutions, the reference resource block is a first resource block of the SS/PBCH block, or wherein the reference resource block is a third resource block of the SS/PBCH block.

In an aspect, a terminal device, comprises a processor, configured to cause the terminal device to: determine that a communication between the terminal device and a network device is operating on a dedicated spectrum of which bandwidth is less than a predetermined bandwidth; and determine a subset of resource blocks from a control resource set, and wherein physical downlink control channel (PDCCH) and corresponding demodulation reference signal (DMRS) resource elements of a resource element group with a resource block outside the subset of resource blocks are set to zero.

In some solutions, the control resource set comprises 24 resource blocks, and the set of resource block comprises a plurality of contiguous resource blocks starting from index 0.

In some solutions, if a parameter equal to all contiguous resource blocks, the PDCCH and the DMRS are mapping in all resource element groups within the subset of resource blocks where the terminal device decodes a physical downlink control channel.

In some solutions, the processor is further configured to cause the terminal device to: determine a field length of frequency domain resource assignment for downlink control information based on a size of the subset of resource blocks.

In some solutions, the number of resource blocks in the subset is indicated in a control resource set configuration.

In some solutions, the subset of resource blocks comprises 15 resource blocks.

In some solutions, the subset of resource blocks comprises resource blocks from a first index to a second index that has a largest resource block index of the control resource set overlapping with a resource block of the SS/PBCH block.

In some solutions, the resource block of the SS/PBCH block is a last resource block of the SS/PBCH block.

In an aspect, a network device, comprises a processor, configured to cause the network device to: determine that a communication between a terminal device and the network device is operating on a dedicated spectrum of which bandwidth is less than a predetermined bandwidth; and transmit, to the terminal device, a synchronization signal/physical broadcast channel (SS/PBCH) block on a PBCH, and wherein a set of resource elements in the PBCH with subcarrier number k is set to zero, the set of resource elements is in one or more resource blocks, and wherein k is relative to a start of the SS/PBCH block and k is in a range from 0 to a first predetermined number and/or a range from a second predetermined number to a total number of subcarriers in the PBCH.

In some solutions, the predetermined bandwidth is 5 MHz, and the total number of subcarriers in the PBCH is 240.

In an aspect, a computer readable medium having instructions stored thereon, the instructions, when executed on at least one processor, causing the at least one processor to perform the method implemented by the device discussed above.

In an aspect, a computer program comprising instructions, the instructions, when executed on at least one processor, causing the at least one processor to perform the method implemented by the device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results.

In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method performed by a terminal device, comprising:
detecting a synchronization signal/physical broadcast channel (SS/PBCH) block at a synchronization raster within a 3 MHz channel bandwidth, the SS/PBCH block being received over a first number of subcarriers,
wherein complex-valued symbols corresponding to resource elements that are part of a common resource block partially or fully overlapping with the SS/PBCH block in the first number of subcarriers and not used for SS/PBCH transmission are set to zero in orthogonal frequency-division multiplexing (OFDM) symbols partially or fully overlapping with OFDM symbols where SS/PBCH is transmitted.

22. The method of claim 21, wherein physical resource blocks (PRBs) containing transmission resources of the SS/PBCH block in the first number of subcarriers are not available for physical downlink shared channel (PDSCH) in the OFDM symbols where the SS/PBCH block is transmitted.

23. The method of claim 21, wherein size of control resource set (CORESET) 0 is a second number of resource blocks within a third number of resource blocks.

24. The method of claim 23, further comprising:
determining size of downlink control information (DCI) format 1_0 based on the size of the CORESET 0 having the second number of resource blocks.

25. The method of claim 23, wherein the third number is 24.

26. A method performed by a network device, comprising:
transmitting a synchronization signal/physical broadcast channel (SS/PBCH) block at a synchronization raster over a first number of subcarriers within a 3 MHz channel bandwidth,
wherein complex-valued symbols corresponding to resource elements that are part of a common resource block partially or fully overlapping with the SS/PBCH block in the first number of subcarriers and not used for SS/PBCH transmission are set to zero in orthogonal frequency-division multiplexing (OFDM) symbols partially or fully overlapping with OFDM symbols where SS/PBCH is transmitted.

27. The method of claim 26, wherein physical resource blocks (PRBs) containing transmission resources of the SS/PBCH block in the first number of subcarriers are not available for physical downlink shared channel (PDSCH) in the OFDM symbols where the SS/PBCH block is transmitted.

28. The method of claim 26, wherein size of control resource set (CORESET) 0 is a second number of resource blocks within a third number of resource blocks.

29. The method of claim 28, further comprising:
determining size of downlink control information (DCI) format 1_0 based on the size of the CORESET 0 having the second number of resource blocks.

30. The method of claim 28, wherein the third number is 24.

31. A terminal device, comprising a processor configured to:
detect a synchronization signal/physical broadcast channel (SS/PBCH) block at a synchronization raster within a 3 MHz channel bandwidth, the SS/PBCH block being received over a first number of subcarriers,
wherein complex-valued symbols corresponding to resource elements that are part of a common resource block partially or fully overlapping with the SS/PBCH block in the first number of subcarriers and not used for SS/PBCH transmission are set to zero in orthogonal frequency-division multiplexing (OFDM) symbols partially or fully overlapping with OFDM symbols where SS/PBCH is transmitted.

32. The terminal device of claim 31, wherein physical resource blocks (PRBs) containing transmission resources of the SS/PBCH block in the first number of subcarriers are not available for physical downlink shared channel (PDSCH) in the OFDM symbols where the SS/PBCH block is transmitted.

33. The terminal device of claim 31, wherein size of control resource set (CORESET) 0 is a second number of resource blocks within a third number of resource blocks.

34. The terminal device of claim 33, wherein the processer is further configured to cause the terminal device to:
determining size of downlink control information (DCI) format 1_0 based on the size of the CORESET 0 having the second number of resource blocks.

35. The terminal device of claim 33, wherein the third number is 24.
